(19) United States
(12) Patent Application Publication
(10) Pub. No.: US 2009/0309079 A1
(43) Pub. Date: Dec. 17, 2009

(54) Jeep hard-top remover

(76) Inventor: Louis Lacina, Prudenville, MI (US)

Correspondence Address: FARRIS LAW, P.C., 5291 COLONY DRIVE NORTH, SAGINAW, MI, 48638, US

(21) Appl. No.: 12/157,931

(22) Filed: Jun. 13, 2008

(51) Int. Cl. B66F 7/26

(52) U.S. Cl. 254/47

(57) ABSTRACT

A device for removing the hard-top from a Jeep vehicle. The device comprises: (1) a tether, sling or the like for attaching to, lifting and supporting the Jeep hard-top, the tether attached to a cable, rope or the like, the cable connected to and held by (2) a horizontal support, the horizontal support received by and attached to (3) a vertical support, and the vertical support attached to (4) a base support. The tether or sling and its attached cable are made to lower and raise the sling, by means of a winch or the like, whereby the hard-top attached thereto may be raised or lowered. The horizontal support may be extended or retracted within a radius in the horizontal plane defined by the horizontal support. The horizontal support is adapted to rotate within the same horizontal plane, thereby causing the Jeep hard-top attached thereto to be swung away from the Jeep, from which the hard-top is removed. The vertical support may be extensible, raised and lowered, with respect to the base support. The base support has a base plate that rests upon the same surface supporting the base support member. The Jeep is positioned so that a tire of the Jeep rests upon the base plate thereby stabilizing the device. A variant of the device includes a larger base plate and a sling having hooks to remove vehicle doors.

### RELATED APPLICATIONS

This application is related to, derived from, and derives priority from U.S. patent application Ser. No. 11/982,933 entitled Jeep Hard-Top Remover, filed Nov. 5, 2007. Application Ser. No. 11/982,933 is included herein by reference.

### FIELD

The present invention relates to the field and art of automotive accessories. More specifically, the present invention comprises a device for removing and installing a hard-top for a Jeep vehicle or the like. In a variant of the disclosed embodiment, the device may be used to remove Jeep doors.

### BACKGROUND

During World War I, the U.S. Army needed a fast, lightweight all-terrain vehicle. In 1940, the Army called on the automotive companies to create a working prototype (fitting army specifications) in forty-nine days. The first jeep prototype was built for the Department of the Army by American Bantam, followed by two other competing prototypes produced by Ford and Willys-Overland. Willys Truck Company was the first company to create the right prototype. The new vehicle was nicknamed the Jeep. General Dwight D. Eisenhower said that America could not have won World War II without it.

Today, more than two million Jeep vehicles cruise the roads and highways of the world. Jeeps are sold with many and various features permitting the vehicles to be driven in traditional as well as “off-the-road” or “sporting” uses. Among these features are a removable hard-top, which is taken off to be driven in spring and summer activities, as then re-installed for traditional driving.

What is needed and not yet provided is an inexpensive, easy-to-use device for removing and installing Jeep hard-tops

### SUMMARY

In response for the need and objectives of an inexpensive and easy-to-use mechanism to facilitate removal and installation of Jeep hard-tops. In an exemplary embodiment, the device comprises (1) a base for supporting other elements of the device; (2) an extensible vertical member that is received and supported by the base; (3) an extensible horizontal member that is attached to, and supported by, the vertical member; (4) a cable having at one end a sling, the cable lowering and raising the sling, the sling attached to the Jeep hard-top; and (5) a hand or electric motor operated winch, which receives the cable, the winch attached to the vertical member, and operated to receive, raise and lower the hard-top. The base has a plate upon which may be driven the Jeep vehicle, whereby the weight of the vehicle stabilizes the mechanism by pressing upon the base plate.

By changing the configuration and structure of the sling the device may also be used to remove vehicle doors.

The device is made to be disassembled, stored, conveyed and reassembled to be used. For example, the device may be made in the form of tubes, pipes, or the like, in thirty-inch sections, which are fitted together to form an adaptive tool, that is extensive in the use of attaching to, lifting and moving a hard-top.

### OBJECTS AND BENEFITS

In the disclosure of an exemplary embodiment, the mechanism will be shown to satisfy several objectives with commensurate benefits. Among these benefits and objectives are a hard-top removing mechanism that is inexpensive and easy to use.

Another benefit is a mechanism that is flexible and may be used anywhere.

And yet another objective is the device is made to be taken apart and re-assembled quickly and to be transported in a compact form.

The objects and advantages of the invention will appear from the disclosure to follow. In the disclosure reference is made to the accompanying drawings, which form a part hereof and in which is shown by way of illustration of an exemplary embodiment in which the invention may be practiced. This embodiment will be described in sufficient detail to enable those skilled in the art to practice the invention, and it is to be understood that other embodiments may be utilized and that structural changes may be made in details of the embodiment without departing from the scope of the invention.

### BRIEF DESCRIPTION OF THE DRAWINGS

FIG. 1 illustrates an exemplary embodiment of the invention, wherein the device of the exemplary embodiment comprises: (1) a base for supporting the device; (2) a vertically extensible vertical support received by and attached to the base; (3) a horizontally extensible support adapted to attach to the vertical support, and (4) a cable or the like that is attached to a ratcheted reel, the reel attached to the vertical member, the reel for reeling the cable, to which is attached a harness or sling for harnessing a hard-top.

FIGS. 2A, 2B, 2C, and 2D show the exemplary embodiment of the device in operation.

FIG. 3 shows the device in the form of components that may be disassembled.

FIG. 4 shows a variant of the exemplary embodiment for removing vehicle doors.

### NOTATION USED IN THE DRAWINGS

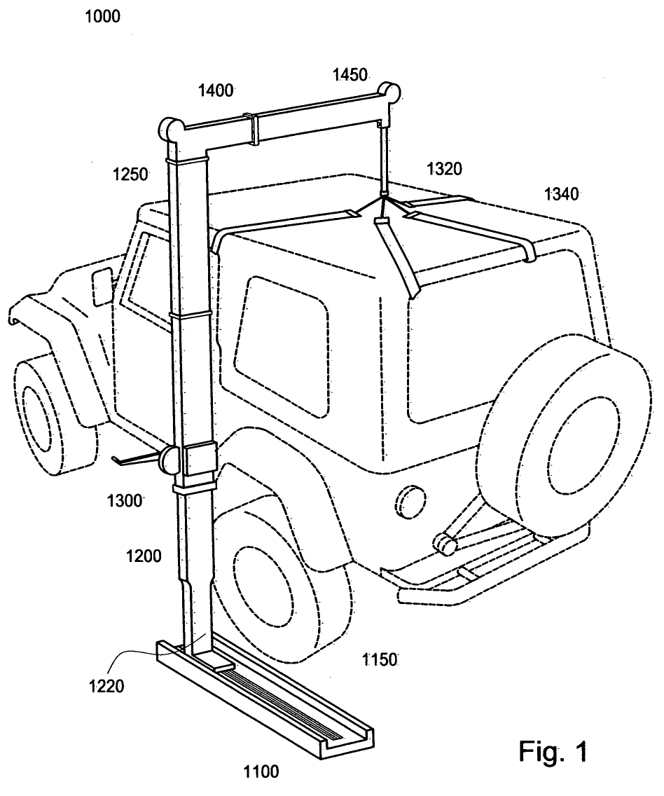

In the drawings, a four digit number is used to designate a component of the device disclosed herein. The first digit is the number of the figure. For example, components shown in FIG. 1 are designated by “1xxx”, where “xxx” is the number assigned to a component.

The following three digit numbers are assigned to the various components of the preferred embodiment:

100 base support member

150 base plate upon which the vehicle rests

200 vertical support member

250 extensible element of the vertical support member

300 lifting mechanism

320 rotary winch with ratchet

340 cable

360 harness

400 extensible, horizontal support member

450 element of extensible, horizontal support member

### DETAILED DESCRIPTION

### Exemplary Embodiment

With reference to FIG. 1, a device 1000 for lifting, holding and manipulating a Jeep hardtop. In FIG. 1, the base 1100 supports the remainder of the device 1000. The base 1100 has a plate 1150, upon which a wheel of the vehicle rests, the weight of the vehicle stabilizing the device 1000.

In FIG. 1, the device 1000 has a vertical support member 1200, the vertical support member 1200 having at least one element 1250 providing for and configured to extend the vertical member 1200. In the exemplary embodiment 1000, the vertical member 1200 is comprised of telescoping elements, such as 1250, wherein an element 1250 fits and slides within the vertical member 1200, or another element, such as 1250.

It should be noted the vertical support member 1200 has a foot 1220 that is adapted to slide horizontally within the base member 1100. In addition, the components, parts and parts of the device 1000 are made to be taken apart and stored or moved while in a compact form.

In FIG. 1, 1400 is a horizontal support that is connected to the top of the vertical support 1100. The horizontal support 1400 is configured with an extensible element 1450, made to slide within the horizontal support 1400.

Further, the device 1000 has a lifting mechanism comprising: (1) a winch or a strap winding and ratcheting mechanism 1300 for winding the strap 1320, to which is attached a harness 1340, which, in turn, is attached to a hard-top.

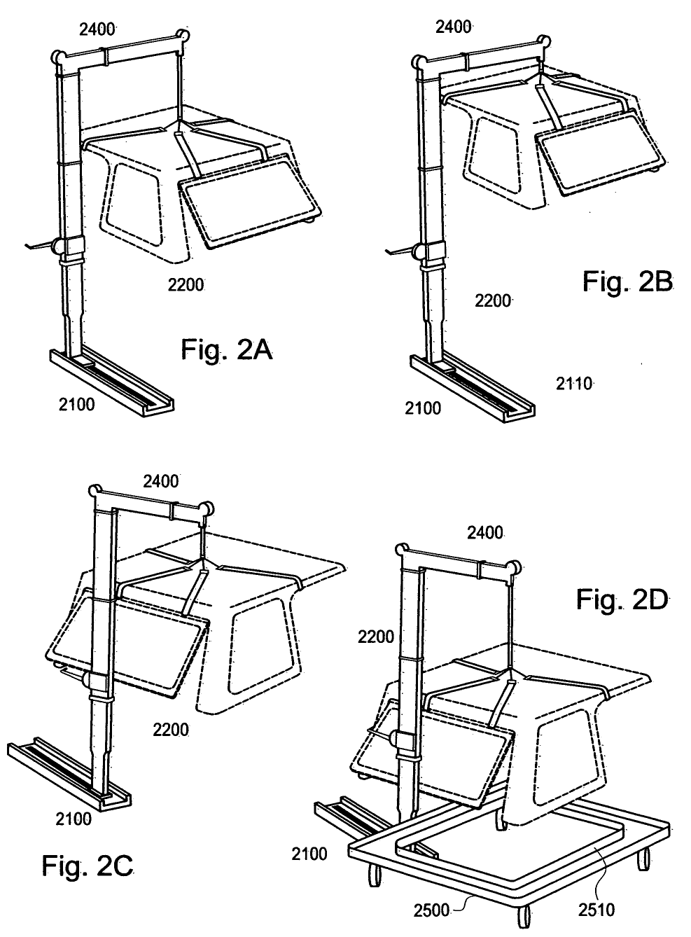

FIGS. 2A-2D show the device in operation. In FIG. 2A, the harness and cable are attached to a hardtop.

FIG. 2B shows the device lifting the hardtop vertically.

In FIG. 2C, the base of the device is shown with a slot 2100 configured to permit the vertical support member 2200 to slide or move within a slot 2110 in the base 2100. In FIG. 2C the vertical support 2200 is slid within the base support 2100, in order to move the hardtop to the rear of the vehicle and to clear the vehicle.

In FIG. 2C, the horizontal support 2400 is then rotated with respect to the vertical support 2200.

In FIG. 2D, the hardtop is lowered, and is received by a rack 2500, which holds the hard top. The rack 2500 has rubber seals 2510, which enclose and protect the edges of the hardtop. The rack 2500 may be then moved elsewhere to secure and protect the hardtop.

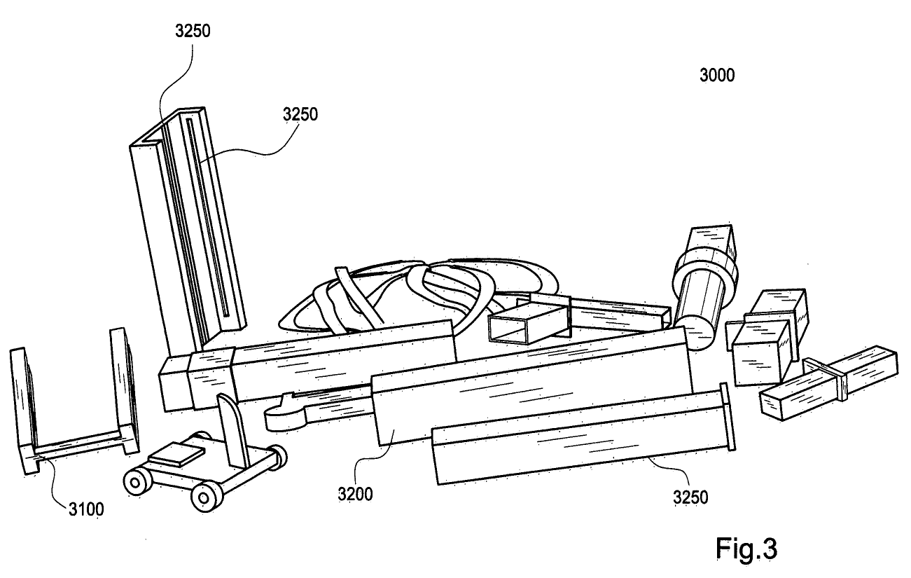

FIG. 3 shows the device made as components, which may be assembled, disassembled and transported easily. In FIG. 3, with respect to the device 3000, all disassembled components, such as the base 3100, vertical elements 3200, 3250 and horizontal elements 3300, and 3350 are made not to exceed 32 inches in length. With this length restriction, all elements or components can be stored in the back of a Jeep. Therefore the device 3000 can be transported with the Jeep, the Jeep hardtop removed and re-installed.

### Additional Configuration of the Exemplary Embodiment

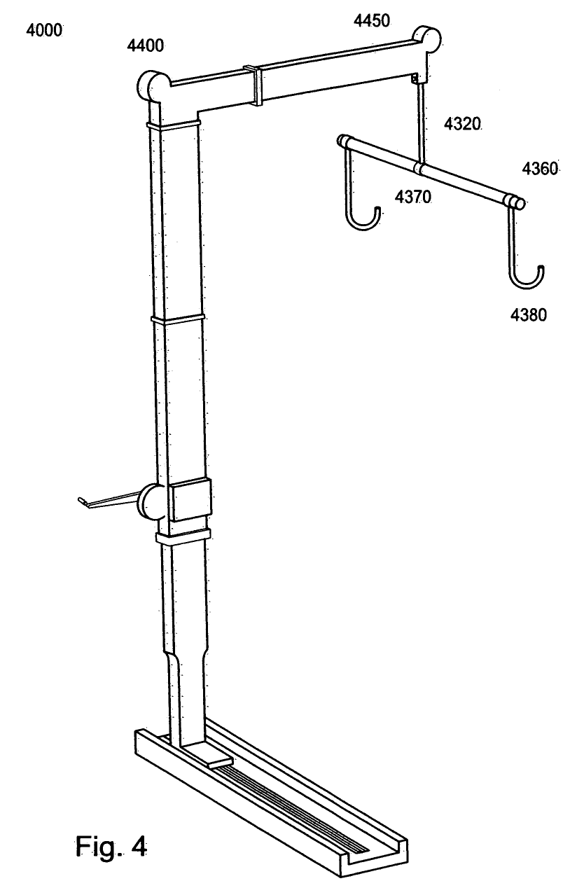

With reference to FIG. 4, the device 4000 may be configured with a larger plate 4150, which permits the device 4000 to be positioned at the center or front of the vehicle, or further away from the vehicle. By providing a different harness 4360 the device 4000 may remove doors from the vehicle.

In FIG. 4, the sling 4360 comprises a bar 4370, which is suspended from the horizontal 4400 and 4450 by a cable 4320. The bar 4370 is provided with a plurality of soft, yet strong hooks 4780, which may be fashioned from rubber, plastic or the like. The hooks 4380 are positioned in an open window of a door, and by use of the device 4000, the door may be lifted from the vehicle.

### DISCLOSURE SUMMARY

The invention has been disclosed in an exemplary embodiment of a device to facilitate the removal of a hard top from a vehicle. A variant of the exemplary embodiment comprises a larger base plate to permit the device to be positioned at the door of a vehicle. The variant also has a sling with hooks to permit the device to be used to remove vehicle doors.

While variations and adaptations of the invention can be made following the teachings of this disclosure, it will appreciated that the limitations of the present invention is most completely defined by the accompanying claims.

I claim:

1. A device for removing a hard-top from a Jeep™, the device comprising a base, the base supporting components of the device, the base having a plate upon which a wheel of the Jeep rests, wherein the components comprise:
a first vertical member removably attached to the base, the first vertical member adapted to receive and hold a second vertical member, the second vertical member adapted to receive a removably attached first horizontal member, the first horizontal member configured to rotate in a horizontal plane with respect to the second vertical member, the first horizontal member adapted to receive a removably attached second horizontal member, and;
a winch attached to at least one of the vertical members, the winch having a cable supported by the second horizontal member, wherein the cable is attached to a Jeep™ hard-top;
whereby the cable may be attached to the hard top and, by action of the winch supported by the vertical members and the horizontal members, the hard-top may be lifted from the Jeep™.

2. The device of claim 1, wherein the base, the first vertical member, the second vertical member, the first horizontal member, and the second horizontal member do not exceed thirty-two inches in length.

3. The device of claim 1, wherein the first vertical member may be rotated in a vertical plane with respect to the base.

4. A device for removing a door from a Jeep™, the device comprising a base, the base supporting components of the device, the base having a plate upon which a wheel of the Jeep rests, wherein the components comprise:
a first vertical member removably attached to the base, the first vertical member adapted to receive and hold a second vertical member, the second vertical member adapted to receive a removably attached first horizontal member, the first horizontal member configured to rotate in a horizontal plane with respect to the second vertical member, the first horizontal member adapted to receive a removably attached second horizontal member, and;
a winch attached to at least one of the vertical members, the winch having a cable supported by the second horizontal member, wherein the cable is attached to a sling comprising a horizontal bar having a plurality of hooks attached to the door;
whereby the sling is attached to the door and, by action of the winch supported by the vertical members and the horizontal members, the door may be lifted from the Jeep™.
